(19) United States
(12) Patent Application Publication
(10) Pub. No.: US 2014/0380386 A1
(43) Pub. Date: Dec. 25, 2014

(54) METHOD AND APPARATUS FOR SEARCHING AND GENERATING A CHANNEL

(71) Applicant: THOMSON LICENSING, Issy de Moulineaux (FR)

(72) Inventor: Neil D. Voss, Darlen, CT (US)

(21) Appl. No.: 14/195,314

(22) Filed: Mar. 3, 2014

Related U.S. Application Data
(60) Provisional application No. 61/775,360, filed on Mar. 8, 2013.

(51) Int. Cl. H04N 21/262; H04N 21/25; H04N 21/462

(52) U.S. Cl. CPC H04N 21/26258; H04N 21/462; H04N 21/251
USPC 725/109

(57) ABSTRACT

A method and apparatus for generating a channel playlist for streaming audio/video content to a user. Specifically, the system is operative to generate a playlist and stream content in response to user provided search terms and statistically relevant information. The system is further operative to store information related to consumed content and provided updated playlists in response to further user requests.

This application claims priority from U.S. Provisional Application No. 61/775,360 filed Mar. 8, 2013.

### BACKGROUND OF THE INVENTION

As more and more media content, such as videos, podcasts, and the like, become available on the internet, users are often overwhelmed by selection and may not watch the content that is most interesting to them. Often users are lost in selection and may spend more time searching for content than watching content. Also, repeatedly searching for content may require a user to consume most of their available time and may not get to watch content that is interesting to them. It would be desirable for a user to be able to perform a search for content while overcoming the above problems.

### SUMMARY OF THE INVENTION

A method and apparatus for generating a channel playlist for streaming audio/video content to a user. The system is operative to generate a playlist and stream content in response to user provided search terms and statistically relevant information. The system is further operative to store information related to consumed content and provided updated playlists in response to further user requests.

In accordance with an aspect of the present invention, an apparatus comprising a receiver for receiving a search request from a user, wherein said search request contains a search criteria, a processor for searching for a plurality of media content in response to said search criteria, prioritizing said plurality of media content in response to a plurality of additional criteria to generate a playlist of prioritized media content, and a transmitter for transmitting a portion of said playlist.

In accordance with another aspect of the present invention, a method comprising the steps of receiving a search request from a user, wherein said search request contains a search criteria, searching for a plurality of media content in response to said search criteria, prioritizing said plurality of media content in response to a plurality of additional criteria to generate a playlist of prioritized media content; and transmitting a portion of said playlist.

### BRIEF DESCRIPTION OF THE DRAWINGS

These and other aspects, features and advantages of the present disclosure will be described or become apparent from the following detailed description of the preferred embodiments, which is to be read in connection with the accompanying drawings.

In the drawings, wherein like reference numerals denote similar elements throughout the views:

FIG. 1 shows a block diagram of an exemplary embodiment of television reception system.

FIG. 2 shows an exemplary digital video receiving system having an active display according to the present invention.

FIG. 3 shows an exemplary process for generating a media channel according to the present invention.

FIG. 4 shows an exemplary process for transmitting a media channel according to the present invention.

FIG. 5 shows an exemplary user interface according to the present invention.

### DETAILED DESCRIPTION OF THE PREFERRED EMBODIMENT

The exemplifications set out herein illustrate preferred embodiments of the invention, and such exemplifications are not to be construed as limiting the scope of the invention in any manner.

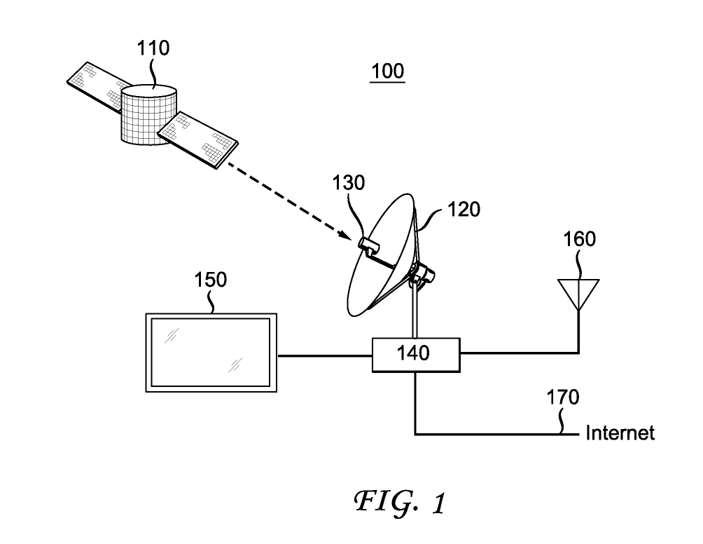

Referring to FIG. 1, a diagram of an exemplary embodiment of a television reception system is shown. FIG. 1 shows a transmitting satellite (110), a parabolic dish antenna (120) with a low noise block (130), a digital satellite set-top box (140), a television monitor (150), a radio frequency antenna (160) and a connection to the internet (170).

Modern televisions and content viewing devices may receive content from a number of sources, including subscription sources such as digital satellite providers and subscription based internet content providers, as well as free sources such as the internet and broadcast television. In a satellite digital television broadcast system, signals are transmitted from a geosynchronous satellite (110). A geosynchronous satellite (110) orbits the earth once each day and sits at approximately 35,786 kilometers above the earth's surface. Since a digital television broadcast satellite (110) generally orbits around the equator it constantly remains in the same position with respect to positions on the ground. This allows a satellite receiving antenna (120) to maintain a fixed look angle.

A digital television transmitting satellite (110) receives a signal from an uplink transmitter and then rebroadcasts the signal back to earth. The altitude of the transmitting satellite (110) allows subscribers in a wide geographical area to receiving the signal. However, the distance from the earth and the severe power conservation requirements of the satellite also result in a weak signal being received by the receiving ground antenna (120). It is therefore critical that the signal be amplified as soon as possible after it is received by the antenna. This requirement is achieved through the placement of a low noise block (LNB) (130) at the feed horn of the parabolic dish antenna (120).

In a digital television transmission system, such as an ATSC broadcast format used in the United States, television stations broadcast content from a central transmitter, which is then received at a user's premises via a radio frequency antenna (160). The signal is then coupled to a set top box (140) or directly to a television (150) with the appropriate tuner. The content is decoded for display to the user.

In an internet television transmission system, content is transmitted via the internet from a service provider to a user's internet connection (170). This internet connection may be a modem, multiplexer, or the like. The content is then coupled to a set top box (140), television (150), mobile device, computer or the like where it is decoded and processed for display to the user.

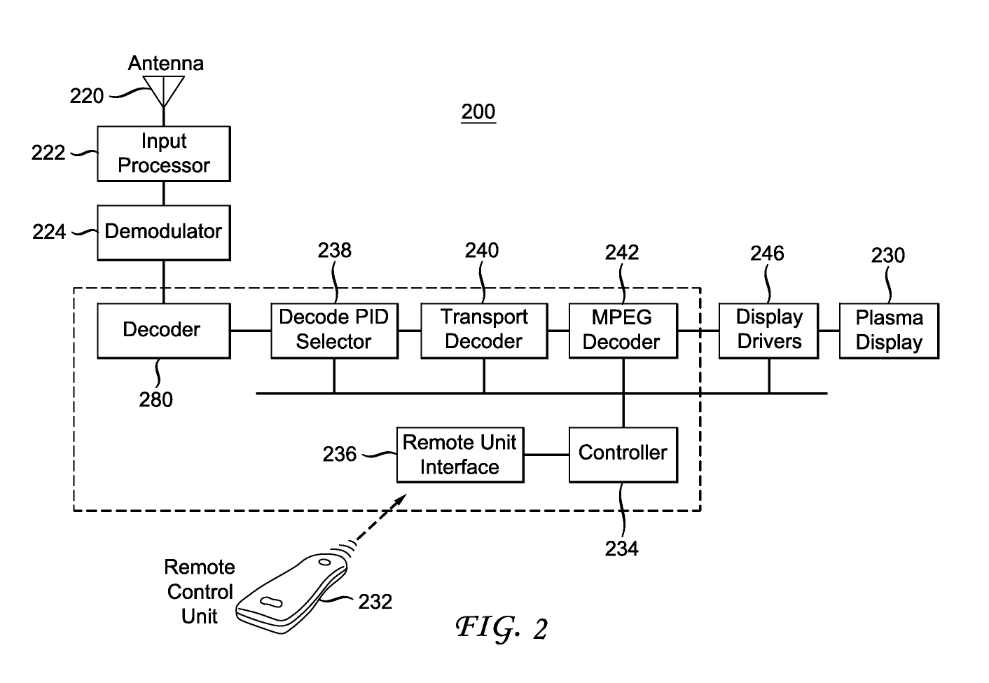

FIG. 2 is a block diagram of an exemplary digital video receiving system (200) according to the present invention. System (200) includes an antenna (220) and an input processor (222) for together receiving and digitizing a broadcast carrier modulated with signals carrying audio, video, and associated data. System (200) also includes a demodulator (224) for receiving and demodulating the digital output from input processor (222). Further, system (200) includes a remote control unit (232) for receiving user input commands. System (200) also includes one or more digital-input-to-digital-output or digital-input-to-analog-output display driver(s) (246) and a respective digital-input or analog-input display (230) for together converting digital video picture data into visual representations. In the preferred embodiment, display (230) is a multiformat television display unit and, accordingly, display driver(s) (246) is a suitable multiformat-input-to-digital-output device. While the present invention is described in regard to the exemplary embodiment of FIG. 2 which includes a display device, the invention is also applicable to systems that do not include a display device such as set top boxes, video cassette recorders, and DVD players.

System (200) further includes a video processor (226). In general, video processor (226) receives user input commands from remote control unit (232), receives the demodulated data from demodulator (224), and transforms the demodulated data into video picture data for display driver(s) (246) in accordance with the user input commands. Accordingly, video processor (226) includes a remote interface (236) and a controller (234). Remote interface (236) receives user input commands from remote control unit (232). Controller (234) interprets the input commands and appropriately controls settings for various components of processor (226) to carry out the commands (e.g., channel and/or on-screen display (“OSD”) selections). Video processor (226) further includes a decoder (280) for receiving the demodulated data from demodulator (224) and outputting a digital signal that is trellis decoded, mapped into byte length data segments, de-interleaved, and Reed-Solomon error corrected. The corrected output data from decoder (280) is in the form of a Moving Picture Experts Group (“MPEG”) standard compatible transport data stream containing program representative multiplexed audio, video, and data components.

Processor (226) further includes a decode packet identifier (“PID”) selector (238) and a transport decoder (240). PID selector (238) identifies and routes selected packets in the transport stream from decoder (280) to transport decoder (240). Transport decoder (240) digitally demultiplexes the selected packets into audio data, video data, and other data for further processing by processor (226) as discussed in further detail below.

The transport stream provided to processor (226) comprises data packets containing program channel data, ancillary system timing information, and program specific information such as program content rating and program guide information.

Using the program specific information, transport decoder (240) identifies and assembles individual data packets including the user selected program channel. Transport decoder (240) directs the ancillary information packets to controller (234) which parses, collates, and assembles the ancillary information into hierarchically arranged tables.

The system timing information contains a time reference indicator and associated correction data (e.g., a daylight savings time indicator and offset information adjusting for time drift, leap years, etc.). This timing information is sufficient for an internal decoder (e.g., MPEG decoder (242), discussed below) to convert the time reference indicator to a time clock (e.g., United States eastern standard time and date) for establishing a time of day and date of the future transmission of a program by the broadcaster of the program. The time clock is useable for initiating scheduled program processing functions such as program play, program recording, and program playback.

Meanwhile, the program specific information contains conditional access, network information, and identification and linking data enabling system (200) to tune to a desired channel and assemble data packets to form complete programs. The program specific information also contains ancillary program content rating information (e.g., an age based suitability rating), program guide information (e.g., an Electronic Program Guide (“EPG”)) and descriptive text related to the broadcast programs as well as data supporting the identification and assembly of this ancillary information.

System (200) also includes an MPEG decoder (242). Transport decoder (240) provides MPEG compatible video, audio, and sub-picture streams to MPEG decoder (242). The video and audio streams contain compressed video and audio data representing the selected channel program content. The sub-picture data contains information associated with the channel program content such as rating information, program description information, and the like. MPEG decoder (242) decodes and decompresses the MPEG compatible packetized audio and video data from transport decoder (240) and derives decompressed program representative data therefrom.

MPEG decoder (242) also assembles, collates and interprets the sub-picture data from transport decoder (240) to produce formatted program guide data for output to an internal OSD module (not shown). The OSD module processes the sub-picture data and other information to generate pixel mapped data representing subtitling, control, and information menu displays including selectable menu options and other items for presentation on display (230). The control and information displays, including text and graphics produced by the OSD module, are generated in the form of overlay pixel map data under direction of controller (234). The overlay pixel map data from the OSD module is combined and synchronized with pixel representative data from decoder (242) under the direction of controller (234). Combined pixel map data representing a video program on the selected channel together with associated sub-picture data is encoded by MPEG decoder (242).

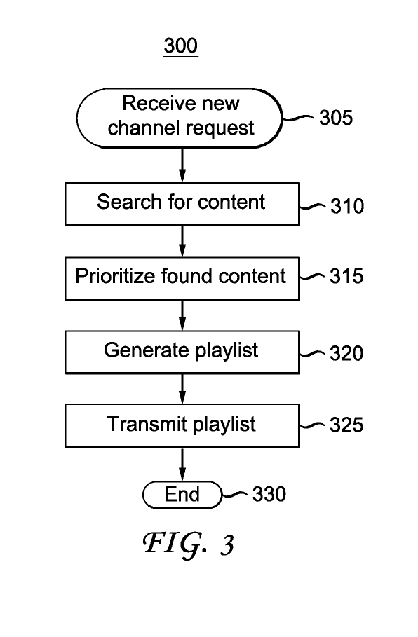

Turning now to FIG. 3, an exemplary process for generating a media channel (300) according to the present invention is shown. The process begins when a request for a new channel is received (305) from a user. The request may be generated from a set top box, a television, a computer, a tablet, a mobile phone or the like, and may be originated from a webpage or an app.

A user generates a new channel request using search terms and other various criteria. The user may use hash tags, geolocation, time of day, media perceptual characteristics, such as average color, tone, speed, pace emotional nuance, etc, or the like to generate the channel request. Additionally, prior preferences, viewing history, current events and the like may be used to augment the search results. For example, if a user requested a search on snowboarding, the Olympics may be included if they are currently being held.

Once the request is received by the service provider, the service provider generates search criteria based on the criteria provided. The service provider then initiates a search for content (310) based on the search criteria and other information held within a user's profile. The user's profile may indicate preferences, history, subscriptions to pay service providers, dislikes of certain providers or certain types of content, such as religious or sports content, and the like.

When the search results are obtained, the service provider then prioritizes the found content (315). This prioritization may be based on a number of factors including length of the content, sate of the content, quality of the content, source of the content, rating of the content provided by viewer feedbank, number of views of the content, number of links to the content, number of reviews of the content, number of public viewers who relate statistically to the given search terms, number of public viewers who relate statistically to the requesting user, the number of public channels where media is published that relate statistically to the given search term, number of single posts of media which relate statistically to the given search term. Additionally, content may be weighted by any number of these factors, with some factors being weighted more heavily than others. Content may further be prioritized higher if the content is associated with a provider that relates statistically to the given search terms. For example, content from General Motors may be given a higher priority when the search terms include Corvette, or NASCAR.

Once the search results are prioritized, the service provider may then generate a playlist (320) in response to the prioritized content. This playlist may then be transmitted to the viewer (325). The user may opt to subscribe to the playlist, or channel, so when the user may return to the playlist at a later time. The user's profile may be updated with the search criteria, the search results, the playlist, or the subscription information. The channel generation procedure in then ended (330).

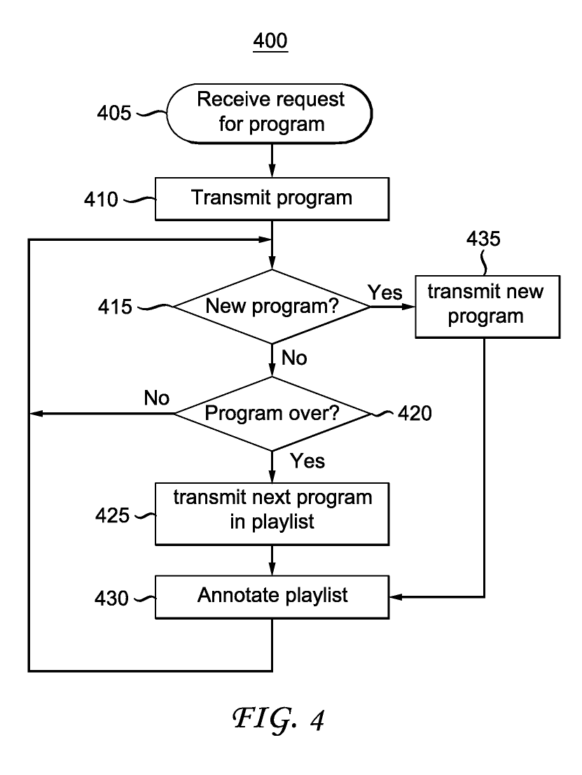

Turning now to FIG. 4, an exemplary process for transmitting a media channel (400) according to the present invention is shown. Once the viewer receives the playlist generated in the process described in FIG. 3, the user may select a program to view from the playlist. Alternatively, along with the playlist, the service provider may transmit the first program in the playlist, which may automatically be played at the user's location. The user may wish to select an alternative program, so a request for a program would be generated at the user's end and transmitted to the service provider.

Once a request for a program is received (405) by the service provider, the service provider may transmit the requested program (410). Transmitting the program may involve stopping transmission of other content or a previous program. The service provider continues to transmit the requested program until a new program is requested (415). If a new program is requested, the service provider stops transmission of the requested program and begins transmission of the new program (435). The service provider may then annotate the playlist to indicate that the new program was requested and the requested program has been displayed to the user. The annotation may include the length of time the requested program was played, etc. The service provider then continues to transmit the new program until another new program is requested (415).

If a new program is not requested, the service provide continues to play the requested program until the program ends (420). Once the program ends, the service provider may transmit the next program in the playlist (425). The playlist is then annotated to indicate that the requested program was viewed in its entirety. The service provider then continues to transmit the next program in the playlist until a new program is requested, or that next program ends. Alternatively, the channel stream may end if an overall timeout is reached where there is no feedback from a viewer. This may indicate that a viewer has left the channel playing but is no longer watching.

The playlist may be annotated (430) to facilitate that content viewed by a user is not reviewed each time the user returns to a channel. Therefore, if a viewer watched the first program and the second program in a playlist, the next time the viewer requests the channel, the service provider with begin to transmit the third program in the playlist. Previously viewed programs in the playlist may be accessed through menu selections of the like in the case the viewer wishers to review previously viewed programs. If a user watched a portion of a program, the program may be either removed from the playlist, similar to a completely viewed program, or the program may be give a lower priority and moved to a later slot in the playlist. The lower priority may be weighted by the amount of time a program was watched or if an overall timeout occurred during transmission of that program.

Additionally, the service provider may user the feedback from the viewer to prioritize the programming from other users in the future. For example, if many users tended to skip through a particular program, this program may be give a lower priority for other users in the future. If many users tended to watch an entire program, or selected a particular program from their playlist, these programs may be give a higher priority when presented in future channel playlists.

The system described permits a service provider to create a channel playlist for a viewer where the viewer may then watch the programming in a manner similar to conventional broadcast channels. Additional content, such as commercials, may be inserted into the program stream as desired by the service provider. When a viewer stops receiving a channel stream, the channel stream may be resumed where the viewer left off. This way, the viewer does not watch previously watched content when the channel stream is resumed, and the unwatched content may be watched in the prioritized sequence.

The service provider, or the viewer, may wish to update the channel playlist either periodically, or whenever the request for the channel is initiated, or at the request of the viewer or service provider, such that new content is placed into the playlist in a prioritized manner and previously watched content is still excluded from the channel playlist. This permits the content of the playlist to be updated without having previously viewed content included in a new search. Thus, a user may continue to watch a desired channel without having to rewatch or filter out previously watched content. Search terms can be used to generate channels that can be consumed and experienced in the same channel metaphor as standard content. Thus it is easy for users to experience content through consistent presentation means and to facilitate discovery of content a user is interested in by allowing them to specify granular parameters and synthesize fresh results for such on a constant basis without added effort.

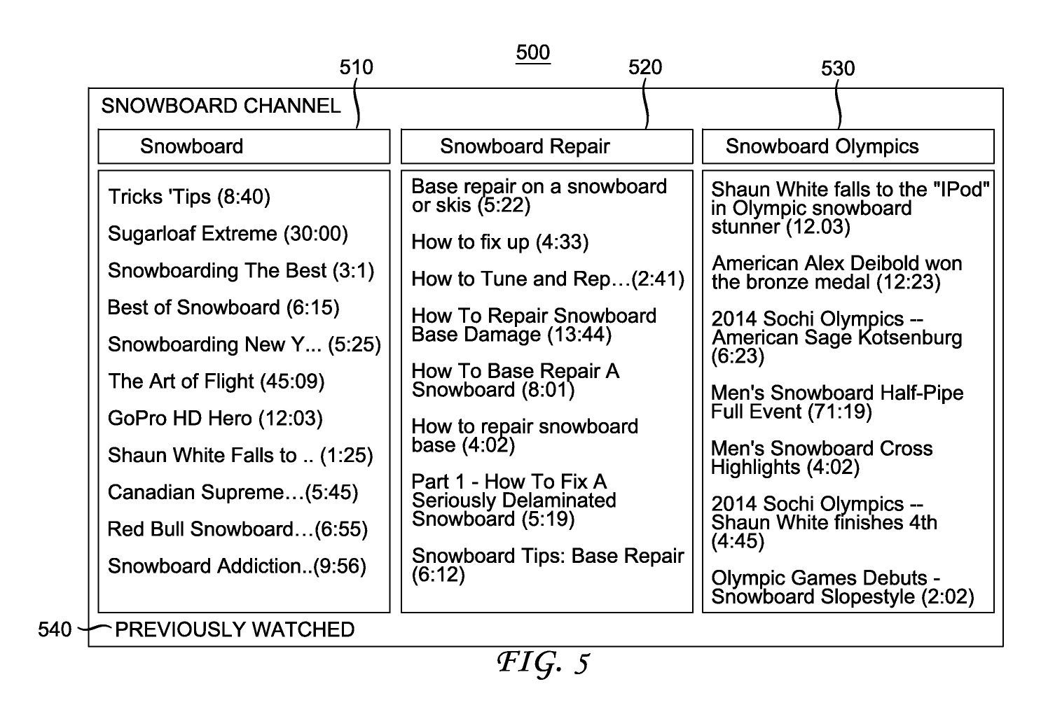

Turning now to FIG. 5, an exemplary user interface (500) according to the present invention is shown. When a playlist is returned to the viewer, it may be presented in a style shown (500). The user interface may present the playlist generated from the requested search terms (510). For this exemplary embodiment, the search term was snowboard as is shown in the title block of the playlist (510). Additionally, the user interface may display additional playlists generated by the service provider (520,530) wherein the additional playlists may be related to the search term but may also include search terms which are statistically relevant to the requested search terms. For example, many users may search for snowboard repair (520) or snowboard Olympics (530). These may be the first two most common multi-term searches including the word snowboard. Alternatively, the service provider may notice that when users search on the word snowboard, that a large number of users select programs related to snowboard repair or snowboard Olympics. These additional playlist channels may be made available to a user for a period of time and may expire if they are not selected by a user. The user interface also provides a selection for a user to see previously watched content (540).

It should be understood that the elements shown and discussed above, may be implemented in various forms of hardware, software or combinations thereof. Preferably, these elements are implemented in a combination of hardware and software on one or more appropriately programmed general-purpose devices, which may include a processor, memory and input/output interfaces. The present description illustrates the principles of the present disclosure. It will thus be appreciated that those skilled in the art will be able to devise various arrangements that, although not explicitly described or shown herein, embody the principles of the disclosure and are included within its scope. All examples and conditional language recited herein are intended for informational purposes to aid the reader in understanding the principles of the disclosure and the concepts contributed by the inventor to furthering the art, and are to be construed as being without limitation to such specifically recited examples and conditions. Moreover, all statements herein reciting principles, aspects, and embodiments of the disclosure, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure. Thus, for example, it will be appreciated by those skilled in the art that the block diagrams presented herewith represent conceptual views of illustrative circuitry embodying the principles of the disclosure. Similarly, it will be appreciated that any flow charts, flow diagrams, state transition diagrams, pseudocode, and the like represent various processes which may be substantially represented in computer readable media and so executed by a computer or processor, whether or not such computer or processor is explicitly shown.

1. A method comprising the steps of:
receiving a search request from a user, wherein said search request contains a search criteria;
searching for a plurality of media content in response to said search criteria;
prioritizing said plurality of media content in response to a plurality of additional criteria to generate a playlist of prioritized media content; and
transmitting a portion of said playlist.

2. The method of claim 1 wherein said plurality of additional criteria includes user preferences.

3. The method of claim 1 wherein said plurality of additional criteria includes popularity of each of said plurality of media content.

4. The method of claim 1 further comprising the step of:
transmitting one of said plurality of media content in response to a ranking in said playlist.

5. The method of claim 4 further comprising the step of:
modifying at least one of said plurality of additional criteria in response to said request.

6. The method of claim 1 further comprising the steps of:
transmitting each of said plurality of media content in response to a ranking in said playlist, wherein each of said plurality of media content is transmitted consecutively.

7. The method of claim 1 further comprising the steps of:
generating a record in response to a program being transmitted;
amending said playlist in response to said record, wherein amending said playlist includes removing programs from said playlist that have been transmitted.

8. The method of claim 1 further comprising the steps of:
receiving a request for a first one of said at plurality of media content;
transmitting said first one of said plurality of media content;
modifying at least one of said plurality of additional criteria in response to said request.

9. The method of claim 8 further comprising the steps of:
receiving request for a second one of said plurality of media content before transmission of said first one of said plurality of media content is completed;
modifying at least one of said plurality of additional criteria in response to said request, wherein said at least one of said plurality of additional criteria is related to said first one of said plurality of media content.

10. The method of claim 1 wherein said plurality of additional criteria includes user recommendations related to said plurality of media content.

11. An apparatus comprising:
a receiver for receiving a search request from a user, wherein said search request contains a search criteria;
a processor for searching for a plurality of media content in response to said search criteria, prioritizing said plurality of media content in response to a plurality of additional criteria to generate a playlist of prioritized media content; and
a transmitter for transmitting a portion of said playlist.

12. The apparatus of claim 11 wherein said plurality of additional criteria includes user preferences.

13. The apparatus of claim 11 wherein said plurality of additional criteria includes popularity of each of said plurality of media content.

14. The apparatus of claim 11 wherein said transmitter is further operative to transmit one of said plurality of media content in response to a ranking in said playlist.

15. The apparatus of claim 14 wherein said processor is further operative to modify at least one of said plurality of additional criteria in response to said request.

16. The apparatus of claim 11 wherein said transmitter is further operative to transmit each of said plurality of media content in response to a ranking in said playlist, wherein each of said plurality of media content is transmitted consecutively.

17. The apparatus of claim 14 wherein said processor is further operative to generate a record in response to a program being transmitted and amend said playlist in response to said record, wherein amending said playlist includes removing programs from said playlist that have been transmitted.

18. The of claim 14 wherein said receiver processor is further operative to receive a request for a first one of said at plurality of media content, said transmitter is further operative to transmit said first one of said plurality of media content and said processor is further operative to modify at least one of said plurality of additional criteria in response to said request.

19. The apparatus of claim 18 wherein said receiver is further operative to receive a request for a second one of said plurality of media content before transmission of said first one of said plurality of media content is completed and said processor is further operative to modify at least one of said plurality of additional criteria in response to said request, wherein said at least one of said plurality of additional criteria is related to said first one of said plurality of media content.

20. The apparatus of claim 11 wherein said plurality of additional criteria includes user recommendations related to said plurality of media content.
